(19) United States
(12) Patent Application Publication
(10) Pub. No.: US 2012/0024166 A1
(43) Pub. Date: Feb. 2, 2012

(54) SMOKE-FREE ROASTER

(76) Inventor: WILLIAM HOME, Taipei (TW)

(21) Appl. No.: 12/846,818

(22) Filed: Jul. 29, 2010

(51) Int. Cl. A47J 37/06

(52) U.S. Cl. 99/425

(57) ABSTRACT

A smoke-free roaster includes a roaster body having a bottom to which a grease collection tray is mounted, a roasting grating mounted on a top of the roaster body, and a heating structure mounted inside the roaster body. The roasting grating includes grating bars, between which solid sloping plates are formed and gently inclined downward from front and rear side edges in a direction along the grating bars toward a central portion of the roaster body and the heating structure comprises reflector assemblies, which includes heating modules respectively mounted below the sloping plates and respectively receive therein carbon fiber heating tubes that irradiate and thus heat the roasting grating and comprise electrical terminals forming power supply connection modules. The sloping plates increase the surface area on the two opposite sides of the roaster body for heat transfer and heat accumulation thereby raising roasting temperature on the two side portions.

### (a) TECHNICAL FIELD OF THE INVENTION

The present invention generally relates to a two-side heating-enhanced smoke-free roaster, which provides a novel structure of roaster that realizes advantages of increased surface area for heat transfer and heat accumulation on opposite side portions of a roaster body for increasing roasting temperature on the two sides of a roasting grating, formation of solid plates between adjacent grating bars at end portions of the sides of the roaster body to conduct grease droppings formed by roasting foodstuffs away from a heating structure to move toward a grease collection tray in order to eliminate incomplete burning, and configuration of pluggable modularized reflector assemblies allowing safe removal and replacement of carbon fiber heating tubes.

### (b) DESCRIPTION OF THE PRIOR ART

With fire being found to roast foods, the roasters become an essential utensil for human beings. Any place that provides a roaster is a place where accommodation can be made and hot food is likely to be available by searching and processing foods.

The development of human society makes people no longer satisfied with the simple ways of roasting by building up a fire under a grating, for the temperature above the grating is often not uniform due to the random distribution of burning charcoals under the grating. Further, the opening area formed in the grating is identical through the whole grating. This makes the temperature on the sides of the grating lower than that at the center of the grating, so that foodstuffs placed on the sides of the grating are hard to get sufficiently cooked and smokes may be caused due to incomplete burning, leading pollution to the atmosphere and hurting to aspiration system of human body. Particularly, grease or juice dropping from a roasted foodstuff to the burning charcoal makes instantaneous local drop of temperature of the charcoal, leading to the generation of a great amount of black smokes and excessive incomplete burning that generates toxicant gas. Further, the foodstuff in roasting may get stained by the charcoal ash, which is no hygiene and may affect the human health.

Further, the conventional roasters are not provided with any means for re-directing thermal radiation, so that any attempt to provide sufficient roasting temperature to all areas of a grating of a roaster often leads to excessive high temperature around the whole roaster, thereby producing smokes from the grease at all possible locations inside the roaster, and therefore leading to a problem of environmental protection.

In view of the above problems, the present invention aims to provide a smoke-free roaster that overcomes these problems.

### SUMMARY OF THE INVENTION

Thus, the present invention aims to provide a smoke-free roaster, which comprises a roaster body having a bottom to which a grease collection tray is mounted, a roasting grating mounted on a top of the roaster body, and a heating structure mounted inside the roaster body, wherein the roasting grating comprises grating bars, between which solid sloping plates are formed and gently inclined downward from front and rear side edges in a direction along the grating bars toward a central portion of the roaster body and the heating structure comprises reflector assemblies, which comprises heating modules respectively mounted below the sloping plates and respectively receive therein carbon fiber heating tubes that irradiate and thus heat the roasting grating and comprise electrical terminals forming power supply connection modules. As such, the sloping plates increase the surface area on the two opposite sides of the roaster body for heat transfer and heat accumulation thereby raising roasting temperature on the two side portions of the roasting grating. This is the primary objective of the present invention.

Further, the two-side heating-enhanced smoke-free roaster according to the present invention uses the sloping plates to conduct the grease droppings that are formed on the two side portions by roasting of foodstuffs away from the heating structure to move toward the grease collection tray so as to protect the carbon fiber heating tubes from being stained by the grease droppings that leads to incomplete burning and also to generate no ash of burning and formation of charcoal, thereby realizing smoke-free roasting, protection of environment, and being good for the health of user. This is another objective of the present invention.

Further, the two-side heating-enhanced smoke-free roaster according to the present invention provides a reflection hood at the rear side of the reflector casing of each of the reflector assemblies to be opposite to the side where the carbon fiber heating tube irradiates the roasting grating for reflecting radiation from the carbon fiber heating tube, whereby the heat generated by the carbon fiber heating tube can be concentrated on the roasting grating to provide the roasting grating with sufficient temperature for roasting and protect the roaster body from excessively high temperature so that greasy liquid formed in roasting foodstuffs that is guided by the sloping plates toward the grease collection tray is not subjected to excessively high temperature to generate smokes and thus roasting that meets the needs of environmental protection is realized. This is a further objective of the present invention.

Further, the two-side heating-enhanced smoke-free roaster according to the present invention uses pluggable modularized reflector assemblies to avoid unnecessary contact with heating tubes that are of high temperature during a replacement operation, which may lead to burning of the operator, whereby safe removal of carbon fiber heating tubes can be realized. This is yet a further objective of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a perspective view of a smoke-free roaster according to the present invention.

FIG. 2 shows an exploded view of the smoke-free roaster according to the present invention.

FIG. 3 shows a cross-sectional view of the smoke-free roaster according to the present invention.

FIG. 4 shows a perspective view of a roasting gating of the smoke-free roaster according to the present invention.

FIG. 5 is a cross-sectional view illustrating heat transfer induced inside the smoke-free roaster according to the present invention.

FIG. 6 is a cross-sectional view illustrating draining of grease caused by heating inside the smoke-free roaster according to the present invention.

FIG. 7 is a perspective view illustrating removal and replacement of carbon fiber heating tubes of the smoke-free roaster according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

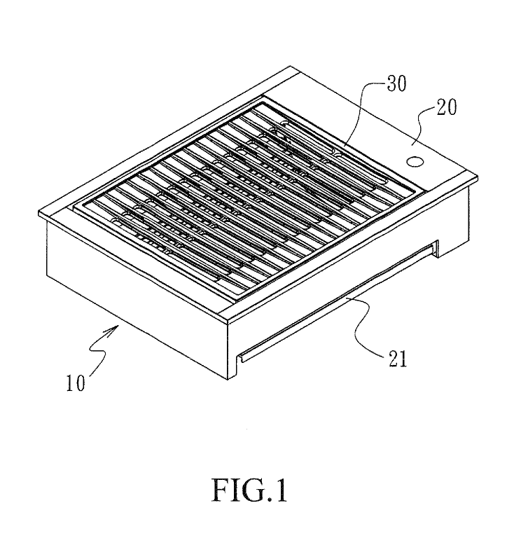

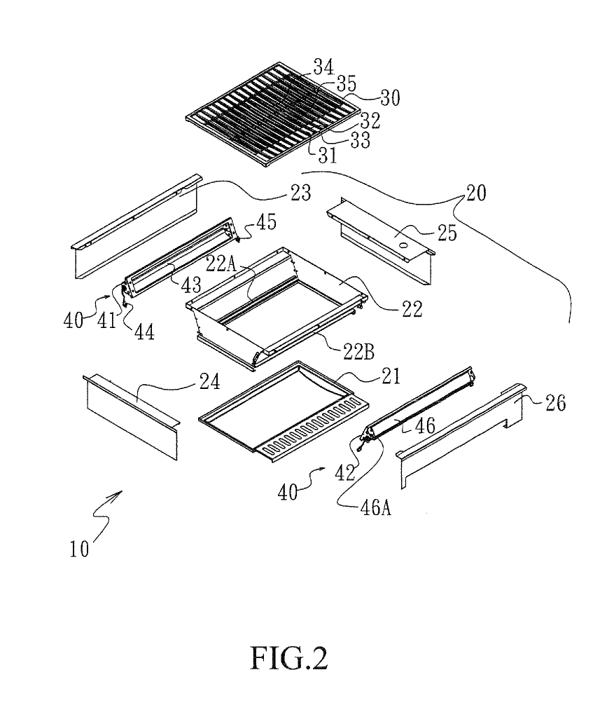

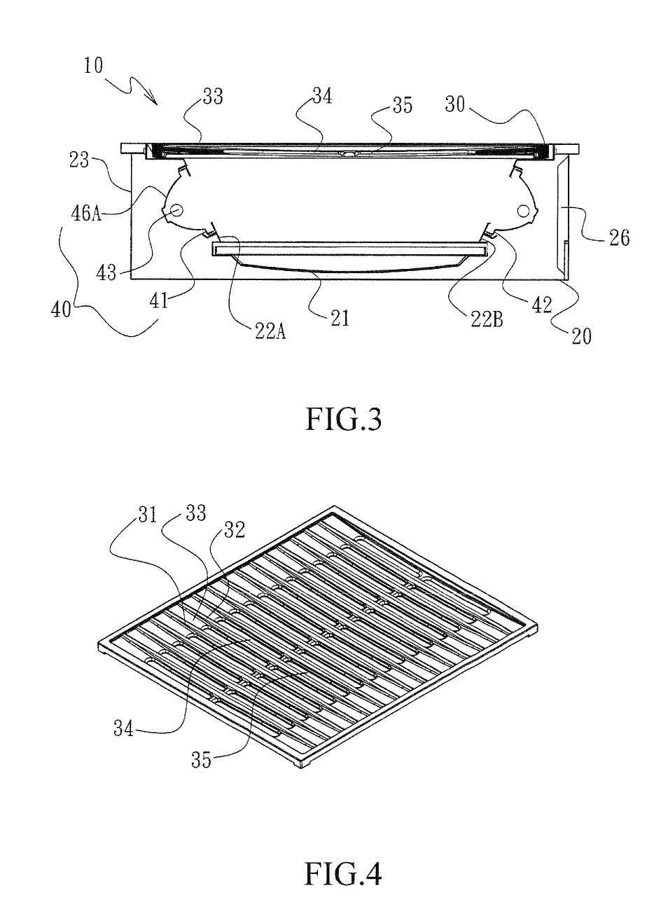

FIG. 1 shows a perspective view of a smoke-free roaster according to the present invention. FIG. 2 shows an exploded view of the smoke-free roaster according to the present invention. FIG. 3 shows a cross-sectional view of the smoke-free roaster according to the present invention. As shown in these drawings, the present invention provides a two-side heating-enhanced smoke-free roaster 10, which mainly comprises a roaster body 20 having a bottom to which a grease collection tray 21 is mounted, a roasting grating 30 mounted on a top of the roaster body 20, and a heating structure 40 mounted inside the roaster body 20. The roasting grating 30 is composed of grating bars 31, 32, between which solid sloping plates 3 are formed at end portions adjacent to opposite sides of the roaster body 20 and gently inclined downward toward a central portion of the roaster body 20. The heating structure 40 comprises two reflector assemblies 41, 42, which are respectively mounted inside the two opposite side portions of the roaster body 20 at locations below the sloping plates 33 and respectively receive therein carbon fiber heating tubes 43 that are provided for irradiating and thus heating the roasting grating 30 and comprise electrical terminals 44, 45 forming connection modules. Specifically, the roaster body 20 is composed of a roaster chassis 22, a rear panel 23, a left panel 24, a right panel 25, a front panel 26, and the grease collection tray 21 that is mounted to the bottom, all being bolted together to define an enclosing configuration. The roaster chassis 22 has two bottom flanges respectively forming inclined walls 22A, 22B inclined upward and respectively corresponding to the rear panel 23 and the front panel 26, whereby receiving spaces are respectively formed between the roaster chassis 22 and the rear panel 23 and between the roaster chassis 22 and the front panel 26 for receiving the reflector assemblies 41, 42. The reflector assemblies 41, 42 comprise reflector casings 46 in which the carbon fiber heating tubes 43 are respectively received and the electrical terminals 44, 45 that are in electrical connection with the carbon fiber heating tubes 43 and project out of the reflector casings 46. A reflection hood 46A is arranged on a back side of each of the reflector casings 46 that is opposite to the side where the carbon fiber heating tube 43 irradiates the roasting grating 30, so that the reflection hood 46A reflects radiation emitting from the carbon fiber heating tube 43.

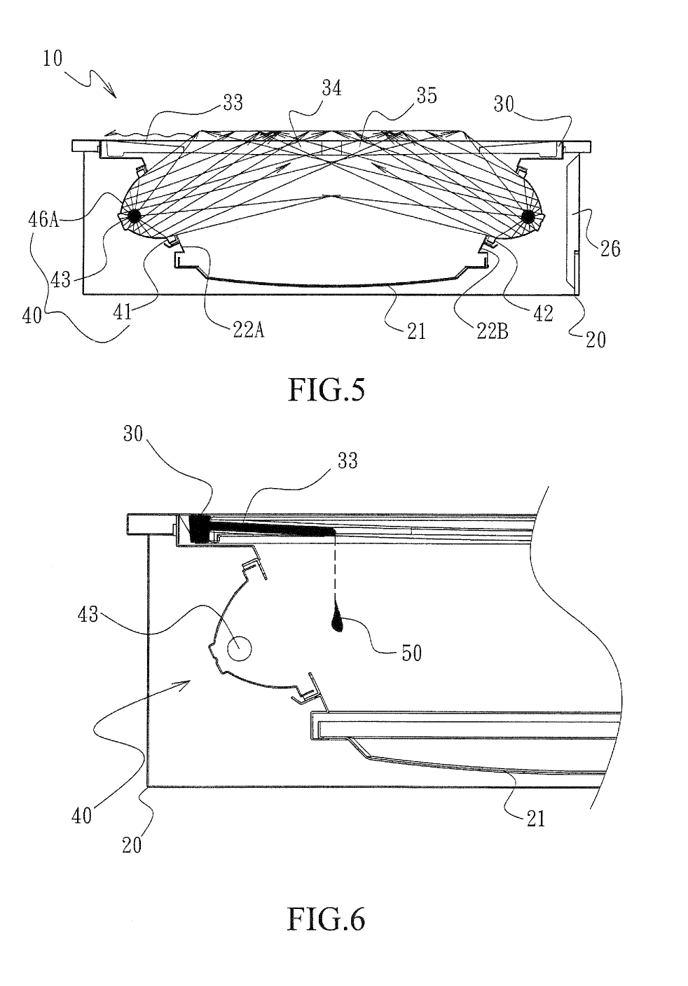

The structure of the roasting grating 30 is shown in FIG. 4. Since the roasting grating 30 comprises the sloping plates 22, which are solid and gently inclined downward toward a central portion thereof, at end portions of adjacent grating bars 31, 32 adjacent to the sides of the roasting grating 30, the roasting grating 30 forms openings 34, 35 that are arranged in the central portion thereof. With such an arrangement, the two side portions of the roasting grating 30 have an increased surface area, whereby in roasting foodstuffs, as shown in FIG. 5 that illustrates transfer of heat, the carbon fiber heating tubes 43 irradiates light and heat toward a central portion of the roaster, and the light and heat transmit through the openings 34, 35 to heat bottom of the foodstuff positioned on the central portion of the roaster, while for those foodstuffs positioned on the two side portions of the roasting grating 30, they are provided with increased surface area formed by the sloping plates 33 on the opposite sides of the roaster body 20 and thus absorb an increased amount of heat transmitted from the central portion of the grating so that the heating efficiency for the foodstuffs positioned on the two side portions of the roaster is improved.

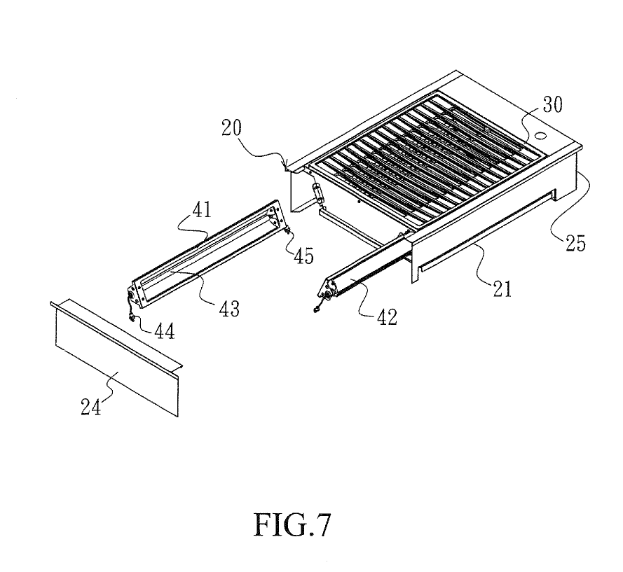

Further, as shown in FIG. 6 that illustrates draining of grease caused by heating, the arrangement of the sloping plates 33 helps conducting the grease droppings 50 generated from foodstuffs on the two sides of the roaster away from the heating structure 40 for moving toward the grease collection tray 21 so as to protect the carbon fiber heating tubes 43 from being stained by grease droppings that leads to incomplete burning. Further, as shown in FIG. 7 that illustrates removal and replacement of the carbon fiber heating tubes, the left panel 24 and/or the right panel 25 is first removed, and the modularized arrangement of the reflector assemblies 41, 42 allows for easy withdrawal thereof for dismounting and replacing the carbon fiber heating tubes 43.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A smoke-free roaster, comprising a roaster body having a bottom to which a grease collection tray is mounted, a roasting grating mounted on a top of the roaster body, and a heating structure mounted inside the roaster body, and characterized in that the roasting grating comprises grating bars, between which solid sloping plates are formed and gently inclined downward toward a central portion of the roaster body so that openings of the roasting grating are all formed in the central portion, providing two side portions of the roasting grating more surface area than the central portion, the heating structure comprising two reflector assemblies, which are respectively mounted inside the two side portions of the roaster body at locations below the sloping plates and respectively receive therein carbon fiber heating tubes that irradiate and thus heat the roasting grating and comprise electrical terminals forming connection modules, the sloping plates functioning to conducting grease dropping away from the heating structure and moving toward the grease collection tray.

2. The smoke-free roaster according to claim 1, wherein the roaster body comprises a roaster chassis, a rear panel, a left panel, a right panel, a front panel, and the grease collection tray that is mounted to the bottom, which are fixed together to define an enclosing configuration, the roaster chassis having two bottom flanges respectively forming inclined walls inclined upward and respectively corresponding to the rear panel and the front panel, whereby receiving spaces are respectively formed between the roaster chassis and the rear panel and between the roaster chassis and the front panel for receiving the reflector assemblies.

3. The smoke-free roaster according to claim 1, wherein the reflector assemblies comprise reflector casings in which the carbon fiber heating tubes are respectively received and the electrical terminals that are in electrical connection with the carbon fiber heating tubes and project out of the reflector casings, a reflection hood being arranged on a back side of each of the reflector casings that is opposite to a side where the carbon fiber heating tube irradiates the roasting grating, so that the reflection hood reflects radiation emitting from the carbon fiber heating tube.
